(19) United States
(12) Patent Application Publication
(10) Pub. No.: US 2012/0135621 A1
(43) Pub. Date: May 31, 2012

(54) FLOATING CONNECTOR

(76) Inventor: Takayuki Hayauchi, Sagamihara-shi (JP)

(21) Appl. No.: 13/388,089

(22) PCT Filed: Aug. 3, 2010
(86) PCT No.: PCT/US2010/044178

§ 371 Date: Jan. 31, 2012

(30) Foreign Application Priority Data
Aug. 7, 2009 (JP) 2009-184661

(51) Int. Cl. H01R 13/64

(52) U.S. Cl. 439/247

(57) ABSTRACT

In one embodiment, the present invention provides a floating connector in which the floating performance can be prevented from deteriorating by the contacts held by the housing so that the reliability of an electrical connection of the connector can be enhanced. In one embodiment, the present invention provides a floating connector in which the floating performance can be prevented from deteriorating by the contacts held by the housing so that the reliability of an electrical connection of the connector can be enhanced. In one embodiment of the present invention, lower contact 4 includes: base contact portion 11a located on one end and coming into contact with circuit board 5; and mutual contact portion 11b located on the other end and coming into contact with upper contact 3. Lower contact 4 is stationarily arranged in lower housing 6. Upper contact 3 includes: upper contact portion 13a located on one end and coming into contact with contact 28 of mating connector 25; and mutual contact portion 13b located on the other end and coming into contact with lower contact 4. Upper contact 3 is movably arranged in upper housing 7. A pushing force, which acts between mutual contact portion 13b of upper contact 3 and mutual contact portion 11b of the lower contact after floating connector 1 has been engaged with mating connector 25, is stronger than a pushing force which acts between mutual contact portion 11b of upper contact 3 and mutual contact portion 13b of lower contact 4 before floating connector 1 is engaged with mating connector 25.

### TECHNICAL FIELD

The present invention relates to a connector. More particularly, the present invention relates to a floating connector capable of being engaged even when a positional displacement exists between the connector and a mating connector.

### BACKGROUND

Patent Document 1 describes an example of the conventional floating connector having an upper and a lower housing which are put on each other in the vertical direction, and the floating connector allows a positional displacement caused between the connector and a mating connector when the upper housing is relatively moved in the horizontal direction with respect to the lower housing. The paragraph No. “0025” of Patent Document 1 describes a state in which a receptacle connector, which is a floating connector having a movable side housing and a stationary side housing, is engaged with a plug connector. The following sentences are described in Patent Document 1. “Movable side housing 20 can be freely moved with respect to stationary side housing 10 through contact 30 for a signal made of elastic material. By a force of moving movable side housing 20 in the lateral direction which is generated by the contact of both slanting surfaces 72a, 23a, movable side housing 20 is moved in a direction (a lateral direction) and both engaging portions 72, 23 are engaged with each other after that. FIG. 12 shows a state in which movable side housing 20 is moved in the lateral direction in a case where central axial face S1 of receiving recess portion 23 of receptacle connector 1 and central axial face S2 of protruding portion 72 of plug connector 70 do not agree with each other, that is, central axial face S1 and central axial face S2 are displaced in the lateral direction. In this case, flexible portion 35 of contact 30 for a signal located on the left in FIG. 12 is deformed so that an interval of the U-shaped lower portion can be reduced and flexible portion 35 of contact 30 for a signal located on the right on the sheet surface is deformed so that the interval of the U-shaped lower portion can be expanded.”

The paragraph No. “0018” of Patent Document 1 makes the following explanations of the contact for electric power supply of the receptacle connector. “Contact 40 for electric power supply includes: first contact 41 for electric power supply held by movable side housing 20; and second contact 45 for electric power supply held by stationary side housing 10.” When plug connector 70 and receptacle connector 1 are mutually engaged with each other, under the condition that first contact portion 44 of first contact 41 for electric power supply and second contact portion 46 of second contact 46 for electric power supply are contacted with each other, contact 75 for electric power supply of plug connector 70 and contacting portion 42 for electric power supply of first contact 41 for electric power supply of receptacle connector 1 are contacted with each other. That is, contact 75 for electric power supply is connected to second contact 46 for electric power supply through first contact 41 for electric power supply. The paragraph No. “0023” makes the following explanations of the advantage of the structure in which contact 40 for electric power supply is divided into first and the second contact 41, 45 for electric power supply. “First flexible portion 44 and second flexible portion 47 are respectively, independently, elastically deformed. Therefore, the second deforming force can be reduced. As a result, even when central axial face S1 of receiving recess portion 23 of receptacle connector 1 and central axial face S2 of protruding portion 72 of plug connector 70 do not agree with each other, movable side housing 20 can be moved in a lateral direction by a relatively low resistance force. Accordingly, receptacle connector 1 and plug connector 70 can be smoothly engaged with each other.”

Patent Document 2 makes a description of another example of the conventional floating connector. The paragraph No. “0028” of Patent Document 2 makes the following explanations of the connector structure body for mutually, electrically connecting the first and the second base with each other. “Connector structure body 20 includes: first connector 22 fixed to first base 24; second connector 23 fixed to second base 25; and transit connector 21 for detachably connecting first connector 22 and second connector 23 with each other. Connectors 21 to 23 respectively have conductors 50, 51, 52 which are conductive linear members. Specifically, first connector 22 has first conductor 50. Second connector 23 has second conductor 52. Transit connector 21 has transit conductor 51. Conductors 50 to 52 are formed out of electric wires made of copper alloy.” First connector 22 has first engaging body 31 which is supported capable of being displaced in a predetermined range in a second direction Y and a third direction X with respect to first housing 30 fixed to first base 24. Transit connector 21 includes: transit housing 130 having transit insertion body 100 engaged with first engaging body 31 capable of being displaced; and transit engaging body 131 capable of being displaced in a predetermined range in a second direction Y and a third direction X with respect to transit housing 130. Second connector 23 includes second inserting body 200 engaged with transit engaging body 131 capable of being displaced of transit connector 21. That is, transit connector 21 can be displaced with respect to first connector 22 and second connector 23 can be displaced with respect to transit connector 21. The paragraph No. “0102” makes the following descriptions. When second connector 23 is connected to first connector 22 through transit connector 21, amounts of floating in a second direction Y and a third direction X can be doubled.

The paragraph No. “0029” of Patent Document 2 makes the following descriptions of a mutual electrical connection of the first and the second base through three conductors 50 to 52 of connector structure body 3. “Under the condition that first connector 22 is fixed to first base 24, first conductor 50 is electrically connected to first electric wire 26 by solder 55. Under the condition that second connector 23 is fixed to second base 25, second conductor 52 is electrically connected to second electric wire 27 by solder 55. Under the condition that transit connector 21 connects first connector 22 with second connector 23, transit conductor 51 electrically connects first conductor 50 with second conductor 52.”

### DOCUMENT OF THE PRIOR ART

Patent Document 1: Official gazette of JP-A-2007-220327

Patent Document 2: Official gazette of JP-A-2007-242561

### SUMMARY

In general, in the case of a floating connector having an upper housing and a lower housing which are put on each other in a vertical direction, the floating performance of the upper housing, which is capable of moving in a horizontal direction with respect to the lower housing fixed onto a base, is affected by the flexibility of contacts accommodated in the housing. In the floating connector, when the upper housing is moved with respect to the lower housing, a positional displacement caused between the connectors engaged with each other is allowed. Therefore, it is preferred that the floating performance is excellent. That is, it is preferred that the upper housing can be easily, relatively moved with respect to the lower housing and it is also preferred that an amount of the relative movement of the upper housing with respect to the lower housing is large.

In the connector in which floating is realized by the elastic deformation of the contacts, the larger the positional displacement of a pair of connectors, the stronger the elastic restoring force generated by the contacts. For example, high stress is generated in a contacting portion of the connector and the base. Accordingly, there is a possibility that the reliability of the contacting portion of the connector with the base is deteriorated. At the time of engaging the connectors with each other, while a connector is moving to a position at which it can be engaged with a mating connector, the connectors are engaged with each other. Therefore, the insertion force tends to be increased.

In one embodiment, the present invention provides a floating connector in which the floating performance can be prevented from deteriorating by the contacts held by the housing so that the reliability of an electrical connection of the connector can be enhanced.

In one embodiment of the present invention, a floating connector having a floating structure comprises: a contact set including a lower contact and an upper contact; a lower housing configured to be fixed onto a base; and an upper housing movably supported by the lower housing, wherein the lower contact is stationarily arranged in the lower housing while the lower contact has a base contact portion, which is provided on one end, coming into contact with the base and the lower contact also has a mutual contact portion, which is provided on the other end, coming into contact with the upper contact, the upper contact is movably arranged in the upper housing while the upper contact has an upper contact portion, which is provided on one end, coming into contact with a contact of a mating connector and the upper contact also has a mutual contact portion, which is provided on the other end, coming into contact with the lower contact, and when the connector is not engaged with the mating connector, the mutual contact portion of the upper contact and the mutual contact portion of the lower contact are not substantially pushed and when the connector is engaged with the mating connector, the mutual contact portion of the upper contact and the mutual contact portion of the lower contact are contacted with each other being pushed.

According to the floating connector of the present invention, when the mutual contact portion of the upper contact and the mutual contact portion of the lower contact are not substantially pushed to each other, the upper housing can be moved with respect to the lower housing. Therefore, the floating function of the floating connector can be maintained. Therefore, the upper housing can be easily moved with respect to the lower housing at the time of engagement. On the other hand, after the connector has been engaged with the mating connector, the mutual contact portion of the upper contact and the mutual contact portion of the lower contact are contacted with each other being pushed. Therefore, the reliability of the electrical connection of the upper contact and the lower contact can be enhanced.

### BRIEF DESCRIPTION OF THE DRAWINGS

FIG. 1 is a sectional view showing a floating connector of one embodiment of the present invention and the mating connector.

FIG. 2 is a sectional view showing a state of the engagement in which the floating connector shown in FIG. 1 and the mating connector are engaged with each other.

FIG. 3 is a perspective view of the floating connector shown in FIG. 1.

FIG. 4 is a perspective view of the mating connector to be engaged with the floating connector shown in FIG. 1, wherein the mating connector is viewed upside down.

FIG. 5 is a sectional view of the floating connector shown in FIG. 3 taken on line A-A.

FIG. 6 is a sectional view showing a variation of the floating connector of the present embodiment.

FIG. 7 is a sectional view showing another variation of the floating connector of the present embodiment.

### DETAILED DESCRIPTION

In the floating connector of the present invention, when a positional displacement caused between the connector and a mating connector which has been previously positioned is allowed, the connectors can be positively connected to each other. Therefore, the floating connector can be applied to an electrical mutual connection between a pair of circuit boards opposed to each other. In the mutual connection between the circuit boards, the floating connector of the present invention is used as a plug connector fixed to one circuit board. The floating connector of the present invention is connected to a receptacle connector fixed to the other circuit board. For example, the floating connector described above can be applied to an input/output interface of a sequencer of FA (Factory Automation) equipment. When the floating connector of one sequencer and the receptacle connector of the other sequencer are connected to each other, the two sequencers are electrically, mutually connected to each other. Concerning the sequencer having both the floating connector and the plug connector as the input/output interface, when the sequencers are connected to each other by the connector connection, a plurality of sequencers can be put on each other in series.

The floating connector of one embodiment of the present invention includes: a pair of ground contacts which are electrically, mutually connected to each other; and a connector housing which holds the pair of ground contacts and is divided into two portions in the vertical direction. The connector housing includes: a lower housing fixed to the circuit board; and an upper housing movably supported by the lower housing. The pair of ground contacts include: a lower ground contact held by the lower housing; and an upper ground contact movably held by the upper housing. The lower ground contact includes: a base contact portion which is provided at a lower end and contacted with a conductor portion of the circuit board; and a mutual contact portion which is provided at an upper end portion and contacted with a lower end of the upper ground contact. The upper ground contact includes: a mutual contact portion which is provided at a lower end and contacted with the mutual contact portion of the lower ground contact; and a contact portion which is provided at an upper end and pushed against the other ground contact of the mating connector. At the initial stage of the engagement of both connectors, the mutual contact portion of the upper ground contact and the mutual contact portion of the lower ground contact are not substantially pushed to each other. Therefore, the upper housing can be easily moved with respect to the lower housing by the upper and the lower ground contact. After both connectors have been connected to each other, an upper contact portion of the upper ground contact is pushed by a ground contact of the mating connector and the upper ground contact is turned. Therefore, the mutual contact portion of the upper ground contact comes into contact with the mutual contact portion of the lower ground contact. Due to the foregoing, in the floating connector of the present invention, at the initial stage of the engagement of both connectors, the floating function can be maintained. After both connectors have been completely engaged with each other, the upper ground contact and the lower ground contact can be positively, electrically connected to each other.

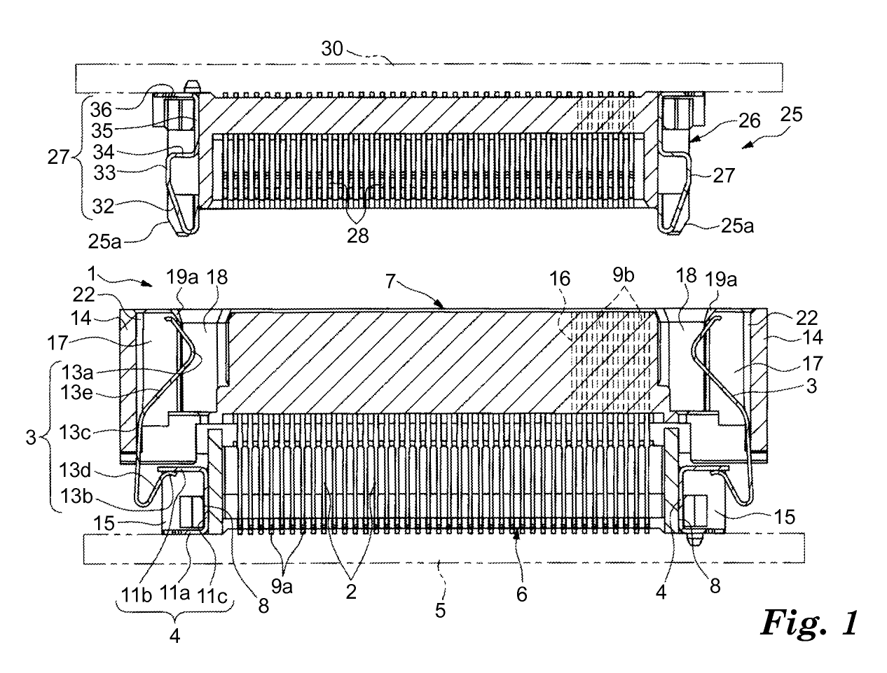

Referring to the drawings, the floating connector of the present invention will be explained below. FIG. 1 shows floating connector 1 of the first embodiment of the present invention. As shown in the drawing, floating connector 1 of the present embodiment is a plug connector directly mounted on the base. Floating connector 1 of the present embodiment includes: a plurality of signal contacts 2 forming a line; a pair of ground contacts 3, 4; and upper and lower connector housing 6, 7 for holding ground contacts 3, 4.

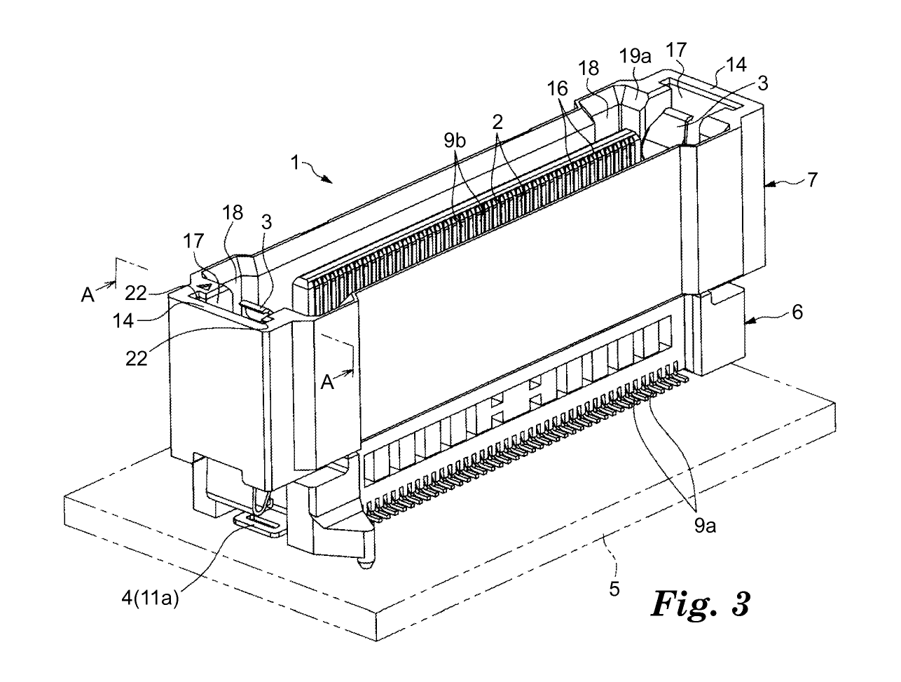

Signal contact 2 can be formed into a pin-shape when a conductive metallic plate, for example, a metallic plate made of copper alloy is punched by a press machine. Concerning this matter, refer to FIG. 3. In the present embodiment, for example, signal contact 2 can be formed in such a manner that the width is approximately 0.3 mm and the thickness is approximately 0.2 mm. A plurality of signal contacts 2 can be formed by punching in such a manner that one end portions of signal contacts 2 are connected to each other at predetermined intervals by a connecting belt. When the plurality of signal contacts 2, which are connected to each other by the connecting belt, are used, the plurality of signal contacts 2 can be assembled to connector housings 6, 7 all at once. After the plurality of signal contacts 2 have been assembled to connector housings 6, 7, the connecting belt is cut off so that individual contacts 2 are separated from each other.

Signal contact 2 is inserted into communication groove 16 communicating connector housings 6, 7 in a vertical direction and press-fitted into and fixed at lower housing 6 and upper housing 7. When individual long and slender signal contacts 2 are deflected, upper housing 7 can be moved with respect to lower housing 6 in a vertical direction. One end of signal contact 2 becomes base contact portion 9a electrically coming into contact with the conductor portion of circuit board 5. The other end of signal contact 2 becomes contact portion 9b coming into contact with contact 28 of mating receptacle connector 25.

In this case, for the convenience of explaining the floating connector of the present invention, an upper side of a vertical direction is determined to be a side on which mating receptacle connector 25 is located and a lower side of a vertical direction is determined to be a side on which circuit board 5 is located. A lateral direction is determined to be a direction in which a plurality of signal contacts 2 are arranged and a direction, which is perpendicular to a vertical direction and a lateral direction, is determined to be a longitudinal direction. A direction of the connector shown in the specification does not restrict a direction of the connector at the time of the actual use.

Ground contacts 3, 4 are formed out of upper ground contact 3 and lower ground contact 4 which are respectively formed as different bodies. In order to enhance the impedance characteristic, contacts, which are thicker and wider than signal contact 2, are used for upper ground contact 3 and lower ground contact 4. In the present embodiment, the ground contact is approximately 3.2 mm wide and 0.2 mm thick. In the same manner as that of signal contact 2, upper ground contact 3 and lower ground contact 4 can be formed by punching a metallic plate made of copper alloy. Upper ground contact 3 and lower ground contact 4 of the present embodiment are respectively formed into predetermined profiles by bending after they have been punched by a press machine. Lower ground contact 4 is formed being bent into a substantial C-shape. Upper ground contact 3 is formed being bent into a shape easily capable of exhibiting a spring property. Ground contact 4 includes: base contact portion 11a, which is arranged at the lower end, coming into contact with a conductor portion of circuit board 5; mutual contact portion 11b, which is arranged at an upper end portion being opposed to base contact portion 11a, coming into contact with upper ground contact 3; and connecting portion 11c provided between base contact portion 11a and mutual contact portion 11b. Upper ground contact 3 includes: mutual contact portion 13b, which is provided on the lower end side, coming into contact with mutual contact portion 11b of lower ground contact 4; upper contact portion 13a, which is provided on the upper end side, pushed by ground contact 27 of mating receptacle connector 25; and supporting portion 13c, which is provided between mutual contact portion 13b and upper contact portion 13a, supported by the inner faces of vertical side walls 14 on both sides of upper housing 7. In upper ground contact 3, the substantially U-shaped curved portion 13d is formed between supporting portion 13c and mutual contact portion 13b. Between supporting portion 13c and upper contact portion 13a, inclination portion 13e is formed which is inclined in a direction separate from an inner face of side wall 14 of upper housing 7 being directed from supporting portion 13c to upper contact portion 13a.

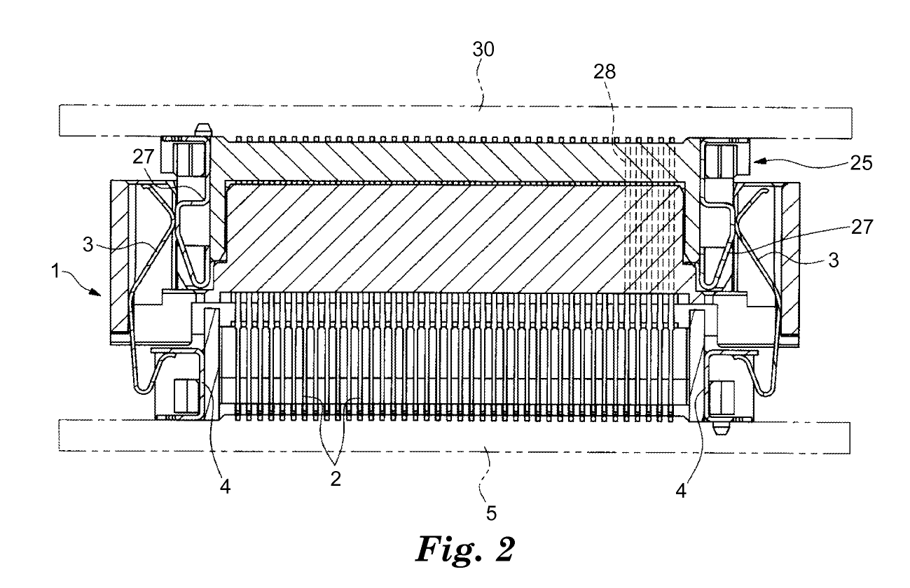

As shown in FIG. 1, before a pair of connectors 1, 25 are engaged with each other, no pushing force substantially acts on mutual contact portions 11b, 13b of ground contacts 3, 4. In this case, no pushing force substantially acts on mutual contact portions 11b, 13b includes a case in which no pushing force acts on mutual contact portions 11b, 13b. Alternatively, no pushing force substantially acts on mutual contact portions 11b, 13b includes a case in which mutual contact portions 11b, 13b push each other so that a friction force generated between mutual contact portions 11b, 13b can not obstruct a relative movement (floating) of upper housing 7 with respect to lower housing 6 at the time of engaging a pair of connectors 1, 25 with each other. Typically, on the assumption that the upper and the lower ground contact are integrated with each other into one body, a force necessary for causing a displacement between the mutual contact portions in a state before the engagement of the connector is lower than a force necessary for elastically deforming the integrated contact. More preferably, as shown in FIG. 1, when connector 1 is arranged on base 5 so that upper housing 7 can be located above lower housing 6, no pushing force acts between mutual contact portions 11b, 13b of upper and lower ground contact 3, 4. That is, before a pair of connectors 1, 25 are engaged with each other, it is unnecessary for mutual contact portions 11b, 13b of upper ground contact 3 and lower ground contact 4 to be elastically, positively contacted with each other. In other words, mutual contact portions 11b, 13b of upper ground contact 3 and lower ground contact 4 may be contacted with each other or may not be contacted with each other. Mutual contact portion 13b of upper contact 3 and mutual contact portion 11b of lower contact 4 are not substantially pushed. As shown in FIG. 2, concerning upper ground contact 3, when upper contact portion 13a is pushed against other side ground contact 27 at the time of the engagement of both connectors 1, 25, upper ground contact 3 is moved in a direction so that upper contact portion 13a can come close to an inner face of vertical side wall 14 of upper housing 7. Accordingly, mutual contact portion 13b comes contact with a lower face of mutual contact portion 11b of lower ground contact 4 by the leverage round the fulcrum of supporting portion 13c.

Lower ground contact 4 and upper ground contact 3 are respectively formed as different bodies. However, as shown in FIG. 1, lower ground contact 4 and upper ground contact 3 are assembled in connector housings 6, 7. That is, lower ground contact 4 and upper ground contact 3 are assembled so that mutual contact portion 13b of upper ground contact 3 can be located in the neighborhood of the lower face of mutual contact portion 11b of lower ground contact 4. In the example shown in the drawing, under the condition of being not pushed, mutual contact portion 13b of upper ground contact 3 comes into contact with the lower face of mutual contact portion 11b of lower ground contact 4. However, lower ground contact 4 and upper ground contact 3 are not necessarily assembled under the condition that mutual contact portion 13b of upper ground contact 3 comes into contact with the lower face of mutual contact portion 11b of lower ground contact 4.

As shown in FIG. 3, the connector housing of holding lower ground contact 4 and upper ground contact 3 includes lower housing 6 and upper housing 7 which are put on each other in a vertical direction. Lower housing 6 and upper housing 7 are respectively formed as different bodies by means of resin molding. Lower housing 6 and upper housing 7 have a plurality of communication grooves 16 into which a plurality of signal contacts are press-fitted in a vertical direction. Under a condition that lower housing 6 and upper housing 7 are put on each other in a vertical direction and positioned to each other in a horizontal direction, the plurality of signal contacts 2 are inserted into communication grooves 16 communicating in a vertical direction. Signal contacts 2 are respectively press-fitted into and fixed at lower housing 6 and upper housing 7 at two positions of the portion close to base contact portion 9a and the portion close to contact portion 9b coming into contact with contact 28 of receptacle connector 25. Upper and lower housing 6, 7 are not fixed to each other but somewhat separated from each other in a vertical direction and fixed to signal contact 2. Therefore, after signal contacts 2 have been press-fitted into upper and lower housing 6, 7, when signal contacts 2 are deflected by the elasticity of signal contacts 2, upper housing 7 can be moved in a horizontal direction in a predetermined allowable range with respect to lower housing 6. Even when lower housing 6 is fixed to circuit board 5, upper housing 7 is moved in a horizontal direction with respect to lower housing 6. Therefore, even when a positional displacement is existing between both connectors 1, 25, the positional displacement is allowed and the connectors can be positively connected to each other.

Ground contacts 3, 4 are respectively arranged on both sides of connector housings 6, 7 in a lateral direction. Connecting portion 11c of substantially C-shaped lower ground contact 4 is press-fitted into and fixed at slit 8 formed on side wall 15 of lower housing 6. Base contact portion 11a of lower ground contact 4 is positioned at the same height in the vertical direction as the height of base contact portion 9a of signal contact 2 soldered or pressed fit to the conductor portion for a signal of circuit board 5. Then, base contact portion 11a of lower ground contact 4 is soldered to the conductor portion for the ground of circuit board 5.

Upper ground contact 3 is movably held in accommodation chamber 17 provided on both side walls 14 of upper housing 7 so that mutual contact portion 13b corresponding to mutual contact portion 11b of lower ground contact 4 can be positioned close to mutual contact portion 11b of lower ground contact 4. Since mutual contact portion 13b is opposed to a lower face of lower ground contact 4 under the condition that upper ground contact 3 is accommodated in accommodation chamber 17, at the time of mounting floating connector 1 on circuit board 5, upper ground contact 3 can be prevented from carelessly slipping out from accommodation chamber 17.

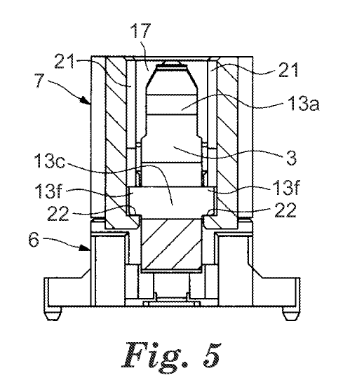

As shown in FIG. 5, upper ground contact 3 has flange portions 13f on both sides. Flange portion 13f is located in groove portion 21 provided on an inner face of accommodation chamber 17 of upper housing 7. In an end portion on lower housing side 6 of groove portion 21, contact portion 22, with which a lower end portion of flange portion 13f comes into contact, is provided. When the lower end of flange portion 13f comes into contact with contact portion 22, upper ground contact 3 is prevented from coming out from upper housing 7, so that it can be kept being accommodated in accommodation chamber 17. The width (the dimension in a lateral direction in FIG. 1) of groove portion 21 is larger than the thickness of upper ground contact 3. Therefore, upper ground contact 3 is pivotally supported by upper housing 7 so that it can be turned round the neighborhood of supporting portion 13c.

Accommodation chamber 17 is arranged being adjacent to guide chamber 18 for guiding receptacle connector 25 when receptacle connector 25 is engaged. Tapered portion (positioning portion) 19a for guiding the engagement of receptacle connector 25 at the initial stage of the engagement of the connector is formed at an opening end of guide chamber 18. At the initial stage of the connector, tapered portion 19 comes into contact with positioning portion 25a of receptacle connector 25 and both connectors 1, 25 are positioned in a horizontal direction. In a case where a positional displacement is existing between both connectors 1, 25, when upper housing 7 is relatively moved in a horizontal direction with respect to lower housing 6, the positional displacement can be allowed. Upper contact portion 13a of upper ground contact 3 is protruded into guide chamber 18 so that it can be pushed to ground contact 27 of receptacle connector 25 at the initial state of the engagement of both connectors 1, 25. When the engagement motion between both connectors 1, 25 advances, upper contact portion 13a of upper ground contact 3 is pushed by ground contact 27 of receptacle connector 25. Therefore, upper ground contact 3 is turned. Upper contact 13a of upper ground contact 3 is moved in a direction so that it can come close to an inner face of side wall 14. By the leverage round the fulcrum of supporting portion 13c of upper ground contact 3 and by the restoring force of the elastic deformation between upper contact 13a of upper ground contact 3 and mutual contact 13b, mutual contact portion 13b of upper ground contact 3 elastically comes into contact with a lower face of mutual contact portion 11b of lower ground contact 4 by a predetermined contact force.

Due to the foregoing, at the initial stage of the engagement of both connectors 1, 25, the upper housing can be displaced with respect to the lower housing by a weak force. Therefore, an insertion force at the time of the engagement can be reduced. After both connectors 1, 25 have been engaged with each other, the reliability of the ground connection of ground contacts 3, 4, 27 is enhanced. That is, in the present embodiment, before both connectors 1, 25 are engaged with each other, it is unnecessary that a contact force is positively generated between mutual contact portions 11b, 13b of ground contacts 3, 4. It is preferable to compose mutual contact portions 11b, 13b of ground contacts 3, 4 in such a manner that mutual contact portions 11b, 13b are contacted with each other after the completion of positioning both connectors and then the pushing force is increased. After both connectors 1, 25 have been engaged with each other, a pushing force acting between mutual contact portions 11b, 13b of upper and lower ground contact 3, 4 is increased to be stronger than the pushing force acting between mutual contact portions 11b, 13b before both connectors 1, 25 are engaged with each other.

A reaction force generated between mutual contact portions 11b, 13b of upper and lower ground contact 3, 4 at the time of the engagement of a pair of connectors 1, 25 acts in a direction so that upper and lower housing 7, 6 can come close to each other. Therefore, even when upper housing 6 is located deviating in a lateral direction with respect to lower housing 7, contact forces at a mutual contact portions 11b, 13b of right and left ground contact 3, 4 can be substantially the same. Even when a positional displacement is caused between upper and lower housing 6, 7, since ground contacts 3, 4 do not contribute to a force acting on base contact portion 9a of signal contact 2 in a direction parallel with base 5, stress acting on base contact portion 9a of signal contact 2 can be minimized. Since no force acts in a direction in which housing 6 is separated from signal contact 2, stress acting on the press-fitting portion of contact 2 and housing 6 can be minimized. Since a force given from wide ground contacts 3, 4 does not substantially affect the floating motion of the upper housing, even when a direction of the displacement of the upper housing is the lateral direction or even when a direction of the displacement of the upper housing is the longitudinal direction, a reaction force given from the lower housing to the upper housing becomes substantially the same. For example, in the case of a connector in which an engagement is made while the ground contact is being elastically compressed in one direction, easiness of the floating motion is greatly different, that is, a reaction force generated by the ground contact is greatly different between a case in which the floating motion is made in a direction of compressing the contact and a case in which the floating motion is made in a direction perpendicular to the direction described above.

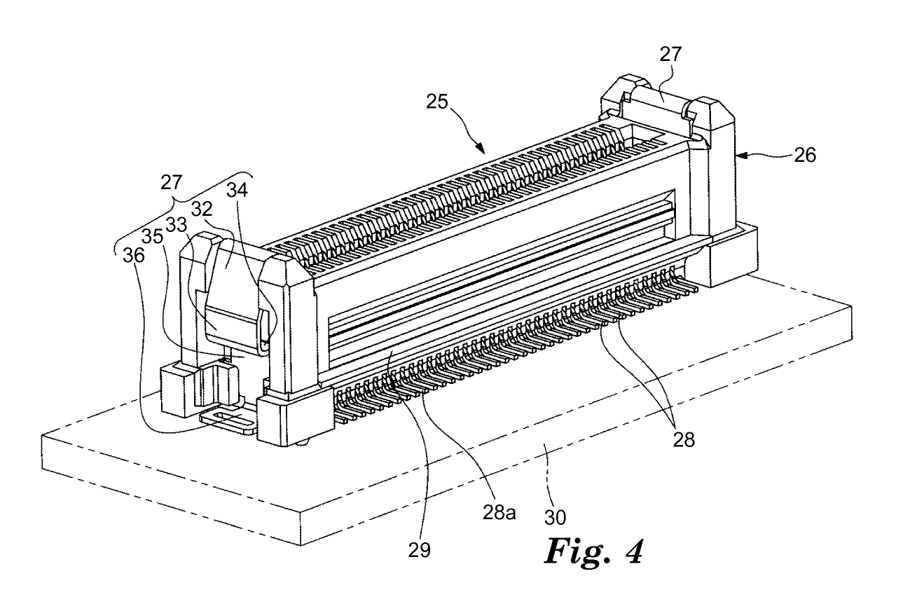

As shown in FIG. 4, receptacle connector 25 engaged with floating connector 1 is a so-called female type connector in which signal contact 2 of floating connector 1 is received between signal contacts 28 which are arranged being opposed to each other. At positions corresponding to a plurality of signal contacts 2 of floating connector 1, a plurality of signal contacts 28 are correspondingly arranged.

Connector housing 26 holding signal contact 28 has hood portion 29 protruding onto a front and a rear wall face so that an insulating sealing agent coated in a portion, in which signal contact 28 and circuit board 30 are soldered to each other, can not leak out. Hood portion 29 is protruded from the side wall of the housing in a substantially parallel direction so that base contact portion 28a of contact 28 can be covered. Hood portion 29 is provided in the housing by a height so that hood portion 29 can not interfere with upper housing 7 of floating connector 1 at the time of the engagement with floating connector 1.

According to the environment of using the connector, base contact portion 28a is coated with an insulating sealing agent and sealed, so that base contact portion 28a can not be exposed. When the sealing agent is coated in a connecting portion of signal contact 28 and circuit board 30, it becomes possible for signal contacts 28, which are arranged being adjacent to each other at short intervals, from being electrically continued to each other when signal contacts 28 are attached with dust or water. Therefore, the reliability of quality of the signal connection can be enhanced. In present connector 25 having hood portion 29, the sealing agent can be prevented from swelling up exceeding hood portion 29. Due to the foregoing, the occurrence of a defective engagement can be prevented. An example of the insulating sealing agent is silicon bond.

Ground contacts 27, which are arranged on both sides of connector housing 26 at positions opposed to ground contacts 3, 4 of floating connector 1, include: pushing portion 33 having a vertical face continued to inclined portion 32, the lower end side of which is inclined inward; horizontal step portion 34 which is substantially bent by a right angle continued to pushing portion 33; vertical connecting portion 35 continued to step portion 34; and base contact portion 36 which is bent outward by a substantially right angle continued to connecting portion 35. Base contact portion 36 is positioned at the substantially same height in a vertical direction as the height of contact portion 9b of signal contact 2. Base contact portion 36 is soldered to the conductor portion for the ground of circuit board 30.

As described above, according to floating connector 1 of the present embodiment, at initial stage of the engagement of both connectors 1, 25, a reaction force is not substantially generated in the electrically contacting portion of upper ground contact 3 and lower ground contact 4. Therefore, upper housing 7 can be easily displaced with respect to lower housing 6. Due to the foregoing, even when a positional displacement is caused between floating connector 1 and other connector 25, the positional displacement between both connectors 1, 25 can be allowed and the connector connection can be positively accomplished. At the stage in which both connectors 1, 25 are completely engaged with each other, ground contacts 3, 4, which are divided into an upper portion and a lower portion in a vertical direction, are elastically contacted with each other by a predetermined contact pressure. Therefore, the reliability of the ground connection can be enhanced. Since the floating connector having a high grounding property is provided, the reliability of the signal connection can be enhanced. It becomes unnecessary to provide a ground contact portion in the device differently from the connector. Therefore, the degree of freedom of designing the device can be enhanced.

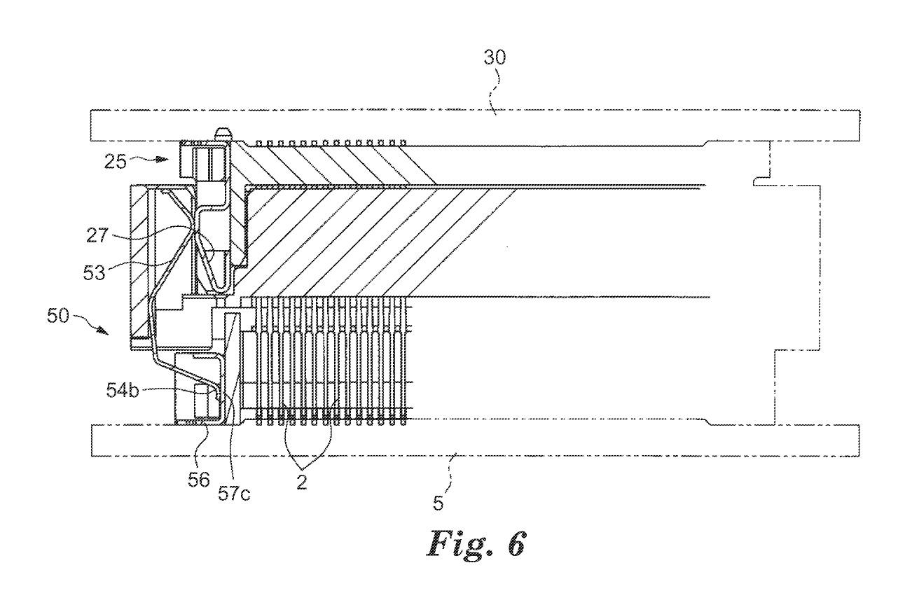

Next, the second embodiment of the floating connector of the present invention will be explained below. As shown in FIG. 6, even in floating connector 50 of the present embodiment, when a pair of connectors 25, 50 are engaged with each other, upper ground contact 53 is turned and mutual contact portion 54b of upper ground contact 53 comes into contact with lower ground contact 56 by the leverage and by the elastic restoring force of the elastic deformation of upper ground contact 53. However, mutual contact portion 54b of upper ground contact 53 comes into contact with a vertical inner face of connecting portion 57c of lower C-shaped ground contact 56. At this viewpoint, the constitution of this embodiment is different from the constitution of ground contacts 3, 4 of the first embodiment. In the present embodiment, a reaction force acting between contact portions 54b, 57c of upper and lower ground contact 53, 56 is generated in a direction substantially parallel with base 5. Even in the constitution of ground contacts 53, 56 of the present embodiment, in the same manner as that of ground contacts 3, 4 of the first embodiment, a pushing force acting between contacting portions 54b, 57c of upper and the lower ground contacts 53, 56 after the engagement is stronger than a pushing force acting between contacting portions 54b, 57c of upper and lower ground contacts 53, 56 before the engagement. Therefore, the upper housing can be easily moved with respect to the lower housing. The other constitution is the same as the constitution of floating connector 1 of the first embodiment. Therefore, the overlapping explanations are omitted here.

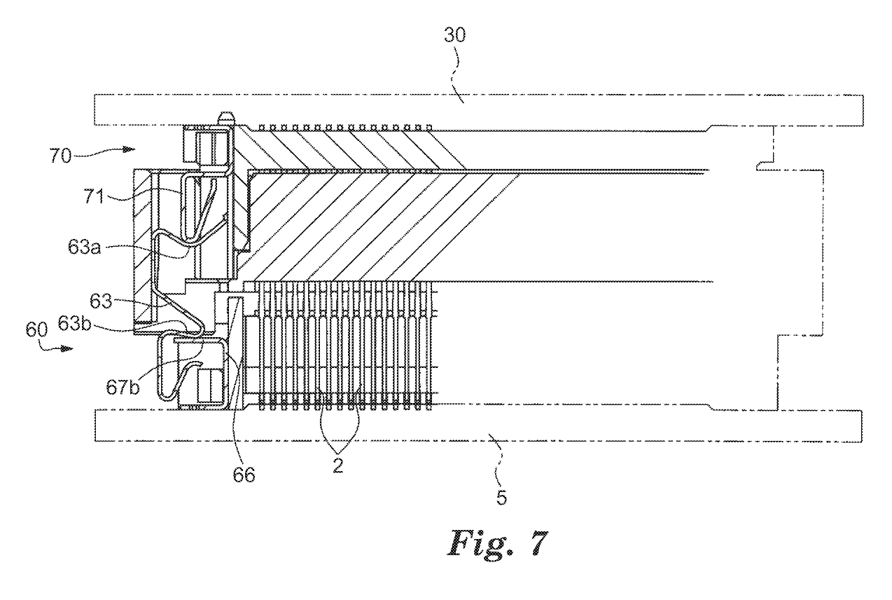

Next, the third embodiment of the floating connector of the present invention will be explained below. As shown in FIG. 7, in floating connector 60 of the present embodiment, upper contact portion 63a of upper ground contact 63 is pushed downward by ground contact 71 of receptacle connector 70. At the point where mutual contact portion 63b of upper ground contact 63 elastically comes into contact with a horizontal upper face of mutual contact portion 67b of lower ground contact 66, upper contact portion 13a of upper ground contact 3 is pushed in a horizontal direction. At this point, the constitution of the present embodiment is different from the constitution of ground contacts 3, 4 of the first embodiment in which mutual contact portion 13b of upper ground contact 3 comes into contact with a horizontal lower face of mutual contact portion 13b of lower ground contact 4. According to the constitution of ground contacts 63, 66 of the present embodiment, lower ground contact 66 is pushed downward by upper ground contact 63. Accordingly, it is possible to enhance a contact force given between base contact portion 67 of lower ground contact 66 and the conductor portion for the ground of circuit board 5.

The floating connector is explained in this specification. However, it should be noted that the present invention is not restricted by the embodiment disclosed here, that is, variations and improvements of the embodiment can be allowed. In the present specification, the constitution of the ground contacts of three embodiments is explained. However, as long as it is the constitution in which no reaction force is substantially generated in the electrically contacting portion of the ground contact divided into two portions in the vertical direction at the initial stage of the engagement of both connectors and in which the ground contact, which has been divided into two portions in the vertical direction, comes into elastic contact by a predetermined contact force, the constitution of the ground contact is not restricted. In the present embodiment, the contact, which has been divided into two portions in the vertical direction, is a ground contact. However, the contact of the present invention, which has been divided into two portions in the vertical direction, can be applied to a signal contact or an electric power supply contact. It is especially preferable that the contact of the present invention is applied to a contact for the ground in which a large sectional area is advantageous for improving the electric characteristic and that the contact of the present invention is applied to a contact for an electric power supply. In the present embodiment, explanations are made into a floating connector having a contact for a signal and a contact for the ground divided into two portions in the vertical direction. However, the floating connector of the present invention includes a connector having only a contact divided into two portions in the vertical direction. Further, the floating connector may have an engagement structure such as a latch so as to maintain an engagement state with the other connector.

### DESCRIPTION OF REFERENCE NUMERALS AND SIGNS

1 Floating connector
3 Upper ground contact
4 Lower ground contact
5 Circuit board
6 Upper housing
7 Lower housing
11a Base contact portion
11b, 13b Mutual contact portion
13a Upper contact portion
19a Tapered portion (Positioning portion)
25 Mating receptacle connector
27 Ground contact
29 Hood portion [Designation of Document]

1. (canceled)

2. A floating connector having a floating structure comprising:
two contacts including a lower contact and an upper contact, which are arranged in said connector being opposed to each other;
a lower housing fixed onto a base; and
an upper housing movably supported by said lower housing, wherein
said lower contact is stationarily arranged in said lower housing while said lower contact has a base contact portion, which is provided on one end, coming into contact with said base and said lower contact also has a mutual contact portion, which is provided on the other end, coming into contact with said upper contact,
said upper contact is movably arranged in said upper housing while said upper contact has an upper contact portion, which is provided on one end, coming into contact with a contact of the mating connector and said upper contact also has a mutual contact portion, which is provided on the other end, coming into contact with said lower contact, and
in said two contacts, a pushing force acting on said mutual contact portion of said upper contact and on said mutual contact portion of said lower contact after said floating connector is engaged with the mating connector is stronger than a pushing force acting on said mutual contact portion of said upper contact and on said mutual contact portion of said lower contact before said floating connector is engaged with the mating connector.

3. The floating connector according to claim 2, wherein when said floating connector is not engaged with the mating connector, said mutual contact portion of said upper contact and said mutual contact portion of said lower contact are not substantially pushed and when said floating connector is engaged with the mating connector, said mutual contact portion of said upper contact and said mutual contact portion of said lower contact are contacted with each other being pushed when said upper contact is moved.

4-6. (canceled)
